(19) United States
(12) Patent Application Publication
(10) Pub. No.: US 2006/0056894 A1
(43) Pub. Date: Mar. 16, 2006

(54) Continuous feed printer

(75) Inventors: Masato Kawashima, Ebina-shi (JP); Hideyuki Namba, Ebina-shi (JP); Hiroshi Kaneyama, Ebina-shi (JP)

Correspondence Address: OLIFF & BERRIDGE, PLC, P.O. BOX 19928, ALEXANDRIA, VA, 22320, US

(73) Assignee: FUJI XEROX CO., LTD., Tokyo (JP)

(21) Appl. No.: 11/067,917

(22) Filed: Mar. 1, 2005

(30) Foreign Application Priority Data
Sep. 16, 2004 (JP) 2004-270197

(51) Int. Cl. G03G 15/00

(52) U.S. Cl. 399/384

(57) ABSTRACT

A continuous feed printer prints images on a continuous paper sheet with conveyance holes perforated at regular intervals along the edges thereof and conveyed by a pinless transportation mechanism. The continuous feed printer includes: a conveyance hole detecting device that detects the conveyance holes on the sheet; a comparison device that compares a measured conveyance length of the sheet, which is a length of the sheet conveyed from the time when the conveyance hole detection has been started to the time when a predetermined number of conveyance holes has been detected, with a calculated conveyance length that is calculated from a number of the detected conveyance holes and the intervals between the conveyance holes; and an adjusting device that adjusts a conveyance velocity of the sheet based on the result of comparison of the measured conveyance length with the calculated conveyance length to make them equal to each other.

### CROSS-REFERENCE TO RELATED APPLICATION

This application claims priority under 35 USC 119 from Japanese Patent Document No. 2004-270197, the disclosure of which is incorporated from reference herein.

### BACKGROUND OF THE INVENTION

1. Field of the Invention

The present invention relates to a continuous feed printer and especially, a continuous feed printer that can form images on a roll of paper with perforations for pin-feed transportation so that the location of conveyance holes formed along the edges of the paper sheet matches the location of images formed on the sheet.

2. Description of the Related Art

A continuous feed printer which prints images on a roll of continuous paper by xerography process has become widely used in recent years since a large number of prints can be made in a short time.

In the continuous feed printer, a toner image is formed on a photoconductor rotating at a constant revolution. A perforated paper sheet is conveyed in accordance with the timing for toner image formation. Then, the toner image is transferred from the photoconductor to the paper sheet and fixed thereon (Japanese Patent Application Laid-Open (JP-A) No. 08-119504).

When a post-processing apparatus such as an automatic envelope-sealing machine is connected to the continuous feed printer to post-process a perforated paper sheet on which the images are printed, the perforated paper sheet is sometimes necessarily conveyed with reference to the position of holes of the perforated paper sheet even when the perforated paper sheet is frictionally transported (so-called “pinless” transportation).

### SUMMARY OF THE INVENTION

The present invention has been made in view of the above circumstance and provides a continuous feed printer in which a perforated paper sheet is conveyed frictionally with reference to the location of holes along the edges of the perforated paper sheet.

An aspect of the present invention provides a continuous feed printer which prints images on a continuous paper sheet with conveyance holes perforated at regular intervals along the edges thereof and conveyed by a pinless transportation mechanism. The continuous feed printer includes: a conveyance hole detecting device that detects the conveyance holes; a comparison device that compares a measured conveyance length of the perforated paper sheet, which is a length of the perforated paper sheet that is conveyed from the time when the conveyance hole detection has been started to the time when a predetermined number of conveyance holes has been detected, with a calculated conveyance length that is calculated from a number of the conveyance holes detected by the conveyance hole detecting device and the intervals between the conveyance holes; and an adjusting device that reduces a conveyance velocity of the perforated paper sheet when the measured conveyance length is longer than the calculated conveyance length and increases the conveyance velocity of the perforated paper sheet when the measured conveyance length is shorter than the calculated conveyance length to make the measured conveyance length equal to the calculated conveyance length.

### BRIEF DESCRIPTION OF THE DRAWINGS

Embodiments of the present invention will be described in detail based on the following figures, wherein:

FIG. 1 is a schematic sectional view showing the configuration of a continuous feed printer related to a first embodiment.

FIG. 2 is a schematic perspective view showing the configuration of the continuous feed printer related to the first embodiment.

FIG. 3 is a perspective view showing an example of a conveyance hole detecting device of the continuous feed printer shown in FIGS. 1 and 2.

FIG. 4 is a perspective view showing another example of the conveyance hole detecting device of the continuous feed printer shown in FIGS. 1 and 2.

FIG. 5 is a process chart showing a process for controlling a conveyance velocity of a perforated paper sheet based on the number of the conveyance holes detected by the conveyance hole detecting device in the continuous feed printer of FIGS. 1 and 2.

FIG. 6A is an explanatory chart showing a locational relation between images formed on the perforated paper sheet and a page line separating consecutive two pages when a measured conveyance length L matches a calculated conveyance length p multiplied by d (wherein p is a number of conveyance holes in one page, and d is an interval between the conveyance holes.).

FIGS. 6B and 6C are explanatory charts showing a locational relation between the images formed on the perforated paper sheet and the page line separating consecutive two pages when a measured conveyance length L does not match a calculated conveyance length p multiplied by d.

### DETAILED DESCRIPTION OF THE INVENTION

As described above, according to an aspect of the present invention, a continuous feed printer includes: a conveyance hole detecting device that detects the conveyance holes; a comparison device that compares a measured conveyance length of the perforated paper sheet, which is a length of the perforated paper sheet that is conveyed from the time when the conveyance hole detection has been started to the time when a predetermined number of conveyance holes has been detected, with a calculated conveyance length that is calculated from a number of the conveyance holes detected by the conveyance hole detecting device and the intervals between the conveyance holes; and an adjusting device that reduces a conveyance velocity of the perforated paper sheet when the measured conveyance length is longer than the calculated conveyance length and increases the conveyance velocity of the perforated paper sheet when the measured conveyance length is shorter than the calculated conveyance length to make the measured conveyance length equal to the calculated conveyance length.

In the continuous feed printer of another aspect, a mechanical hole detector detecting the conveyance holes mechanically and an optical hole detector detecting the conveyance holes optically can be employed as the conveyance hole detecting device.

With the mechanical hole detector, the conveyance holes may be accurately detected.

The mechanical hole detector may be a sprocket wheel having teeth that engage with the conveyance holes and detecting the conveyance holes by rotating.

Alternatively, the optical hole detector may include an optical conveyance hole detector detecting the conveyance holes by an optical sensor.

With the optical hole detector, the conveyance holes may be detected regardless of the intervals thereof without contacting to the perforated paper sheet.

The continuous feed printer may be configured so as to interpret that the continuous feed printer itself has jammed in case when the conveyance hole detecting device does not detect a conveyance hole next to a specific conveyance hole after a predetermined time has passed since the specific conveyance hole is detected.

With the above configuration, jamming of the continuous feed printer may be detected without any additional device.

Further, according to another aspect, the continuous feed printer may be configured to allow a user to select whether a perforated paper sheet is conveyed with reference to a conveyance hole location or conveyed with reference to an inner standard not based on the conveyance hole location. Thus, the perforated paper sheet can be conveyed as the user requires.

### 1. A First Embodiment

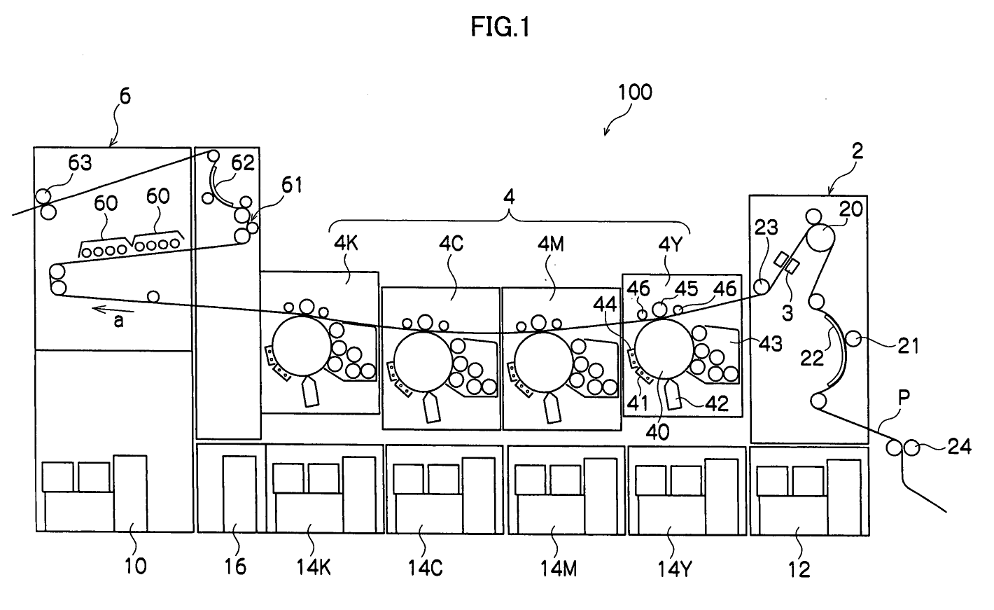

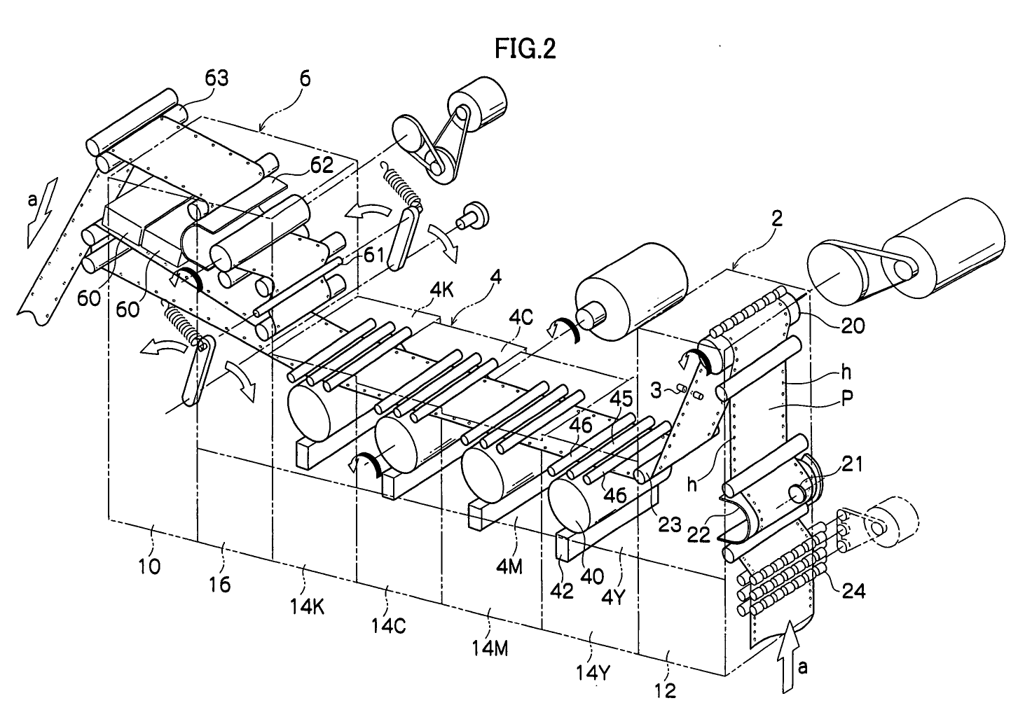

As shown in FIGS. 1 and 2, a continuous feed printer 10 related to the first embodiment is an electrophotographic printer and has a paper feeding section 2, an image-forming section 4 forming a full-color toner image and transferring it to a paper sheet P perforated for pin-feed transportation (hereinafter, referred to as “perforated paper sheet P”), and an image-fixing section 6 fixing the toner image transferred to the perforated paper sheet P. The paper feeding section 2, the image-forming section 4, and the image-fixing section 6 are disposed from the upstream side to the downstream side with respect to a conveyance direction ‘a’ of the perforated paper sheet P wherein conveyance holes h are perforated at specific intervals along both edges thereof.

The paper feeding section 2 includes a back tensioning roller set 24, an aligning roller 21, a main driving roller 20, and a paper sheet-directing roller 23 from the upstream side to the downstream side with respect to the conveyance direction ‘a’. A conveyance hole detecting apparatus 3 is provided at a location between the main driving roller 20 and the paper sheet-directing roller 23.

The main driving roller 20 nips under a specific pressure and carries the perforated paper sheet P at a specific conveyance velocity with respect to the conveyance direction ‘a’.

The aligning roller 21 aligns the perforated paper sheet P upstream of the main driving roller 20 in co-operation with a guide member 22 that is partially cylindrical so that the perforated paper sheet P is conveyed in a uniform conveying path.

The back tensioning roller set 24 has, for example, 3 pairs of rollers rotating in the same rotating direction of the main driving roller 20 at a lower rotating velocity so as to provide a tension to the perforated paper sheet P upstream of the main driving roller 20.

The conveyance hole-detecting apparatus 3 corresponds to the conveyance hole-detecting device of the present invention and functions to detect the conveyance holes h of the perforated paper sheet P.

The image-forming section 4 includes, from the upstream side to the downstream side with respect to the conveyance direction ‘a’, a Y-color image-forming section 4Y forming a yellow (hereinafter, referred to as “Y-color”) toner image, an M-color image-forming section 4M forming a magenta (hereinafter, referred to as “M-color”) toner image, a C-color image-forming section 4C forming a cyan (hereinafter, referred to as “C-color”) toner image, a K-color image-forming section 4K forming a black (hereinafter, referred to as “K-color”) toner image.

The Y-color image-forming section, the M-color image-forming section, the C-color image-forming section, and the K-color image-forming section respectively has a photoconductor 40 that rotates in a direction b, a corona-charging device 41, a laser-exposure device 42 that is located downstream of the corona-charging device 41 in the rotating direction b, a developing device 43 that is located downstream of the laser-exposure device 42 in the rotating direction b, a transferring roller 45 facing the photoconductor 40 with a conveying path of the perforated paper sheet P, and a pair of transfer guide rollers 46 that are located upstream and downstream of the transferring roller 45 in the rotating direction b. A discharging device 44 is provided upstream of the corona-charging device 41 in the rotating direction b.

An electrostatic latent image is formed on the surface of the photoconductor 40. The corona-charging device 41 charges the surface of the photoconductor 40 at a specific voltage. The laser-exposure device 42 exposes image-wise the photoconductor 40 charged by the corona-charging device 41. The developing device 43 develops the latent image formed on the photoconductor 40 by the laser-exposure device 42 with a developing agent containing a magnetic carrier and a toner to form Y, M, C, and K-colored toner images. The transferring roller 45 and the transfer guide rollers 46 press the perforated paper sheet P onto the photoconductor 40 and transfer the toner images formed on the surface of the photosensitive roller 40 to the perforated paper sheet P.

The image-fixing section 6 includes a flash-fixing apparatus 60 fixing the toner-images transferred to the perforated paper sheet P by flashes, tension-providing device 61 providing tension to the perforated paper sheet P in a downstream side of the flash-fixing apparatus 60 with respect to the conveyance direction ‘a’, an aligning device 62 adjusting the conveying path of the perforated paper sheet P in a width direction at a section downstream of the tension-providing device 61, and a pair of tensioning rollers 63 that are disposed near an exit of the continuous feed printer 100 and nip the perforated paper sheet P and rotate at a peripheral velocity faster than the conveyance velocity of the perforated paper sheet P so as to provide a tension to the perforated paper sheet P.

Additionally, the continuous feed printer 100 includes a total control computer 10, a paper sheet-transporting control computer 12 controlling the paper feeding section 2, a Y-color image formation control computer 14Y controlling the Y-color image-forming section 4Y, an M-color image formation control computer 14M controlling the M-color image-forming section 4M, a C-color image formation control computer 14C controlling the C-color image-forming section 4C, a K-color image formation control computer 14K controlling the K-color image-forming section 4K, and an image-fixing control computer 16 controlling the image-fixing section 6.

Hereinafter, the Y-color image formation control computer 14Y, the M-color image formation control computer 14M, the C-color image formation control computer 14C, and the K-color image formation control computer 14K may sometimes generally be referred to as “image-formation control computer 14”.

The paper sheet-transporting control computer 12, the Y-color image formation control computer 14Y, the M-color image formation control computer 14M, the C-color image formation control computer 14C, the K-color image formation control computer 14K, and the image-fixing control computer 16 are controlled by the total control computer 10.

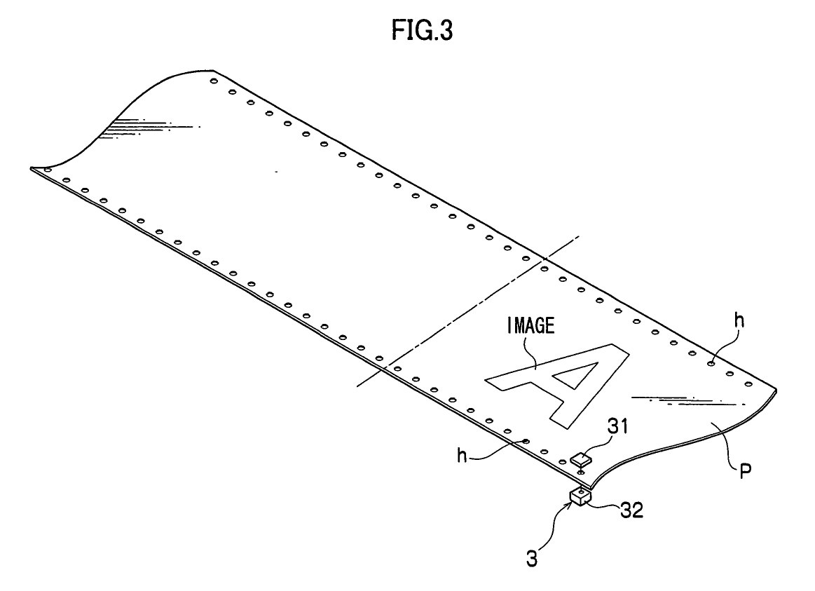

The conveyance hole-detecting apparatus 3 has a light-emitting device 32 and a light-receiving device 31. When a conveyance hole h passes between the light-emitting device 32 and the light-receiving device 31, light emitted from the light-emitting device 32 is received by the light-receiving device 31 and the conveyance hole h is detected, as shown in FIG. 3.

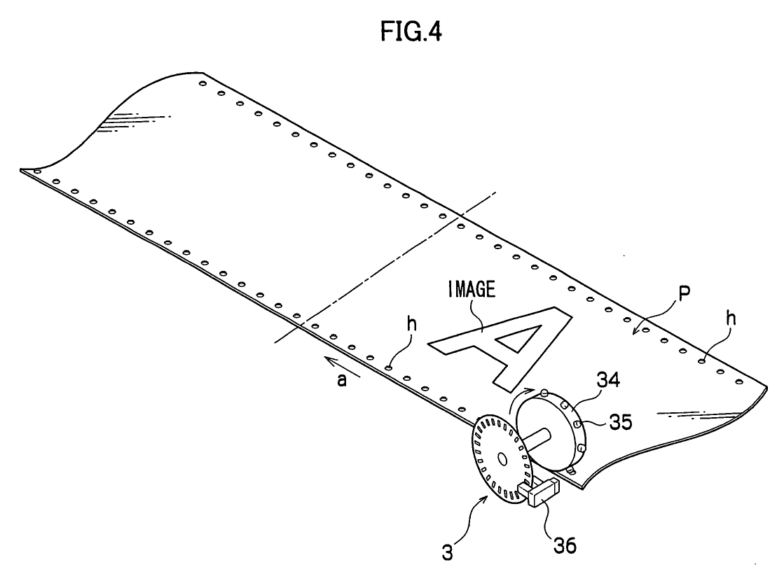

Another example of the conveyance hole-detecting apparatus 3 includes an apparatus having a sprocket wheel 34 with protrusions 35 that are provided at regular intervals on the periphery thereof so as to engage with the conveyance holes h, and a rotary encoder 36 detecting rotation of the sprocket wheel 34, as shown in FIG. 4.

The continuous feed printer 100 can be operated in a normal conveyance mode wherein the perforated paper sheet P is conveyed not with reference to the location of conveyance holes h but with reference to an inner standard, or in a conveyance hole reference mode wherein the perforated paper sheet P is conveyed with reference to the location of the conveyance holes h.

The mode to operate the continuous feed printer 100 can be selected in accordance with an instruction by the total control computer 10 or an instruction shown on an operating panel not shown. An additional function of inquiring a user which mode is to be selected can be added to the functions of total control computer 10.

Hereinafter, operation of the printer for continuous paper 100 under the conveyance hole reference mode will be described.

When an image data is input, the total control computer 10 drives the photoconductors 40 of the Y-color image-forming section 4Y, the M-color image-forming section 4M, the C-color image-forming section 4C, and the K-color image-forming section 4K at a first specific peripheral velocity through the image-formation control computer 14. The total control computer also controls the paper feeding section 2 through the paper sheet-transporting control computer 12. Simultaneously, the total control computer 10 controls the tensioning rollers 63 through the image-fixing control computer 16 so as to provide a constant tension and convey the perforated paper sheet P at a specific conveyance velocity with respect to the conveyance direction ‘a’.

At the same time, the total control computer 10 starts the conveyance hole detecting apparatus 3 to detect the conveyance holes h of the perforated paper sheet P.

Then, the conveyance hole-detecting apparatus 3 detects the conveyance holes h and inputs data of detecting the conveyance holes h to the total control computer 10. The total control computer 10 calculates a number of the conveyance hole h that the conveyance hole detecting apparatus 3 has detected based on the data from the conveyance hole detecting apparatus 3 by a procedure to be mentioned below. Then, the total control computer 10 controls the paper feeding section 2 so that the perforated paper sheet P is conveyed at an appropriate conveyance velocity (that is, a second specific conveyance velocity) having a specific relation with the first specific conveyance velocity of the photoconductor 40. Although, in the present embodiment, the second specific conveyance velocity is slightly slower than the first specific conveyance velocity, the second specific conveyance velocity can be the same or higher than the first specific conveyance velocity.

On the other hand, the total control computer 10 separates the input image data into Y-color, M-color, C-color and K-color image data. Then, the total control computer inputs the separated image data into the Y-color image formation control computer 14Y, the M-color image formation control computer 14M, the C-color image formation control computer 14C, and the K-color image formation control computer 14K, respectively.

When image data are input to the image formation control computer 14, the image formation control computer 14 controls the Y-color image-forming section 4Y, the M-color image-forming section 4M, the C-color image-forming section 4C, and the K-color image-forming section 4K so that toner images are formed by the following procedure.

Firstly, the photoconductor 40 is charged by the corona-charging device 41 and exposed image-wisely by the laser-exposure device 42 in accordance with the image data to form a latent image on the photoconductor 40.

Then, toner is applied to the latent image on the photoconductor 40 to form Y-, M-, C-, and K-color toner images.

The toner image formed on the surface of the photoconductor 40 is transferred to the perforated paper sheet P by the transferring roller 45 and the transfer guide rollers 46.

The perforated feeding paper P passes the Y-color image-forming section 4Y, the M-color image-forming section 4M, the C-color image-forming section 4C and the K-color image-forming section 4K and thus, the Y-color toner image, the M-color toner image, the C-color toner image and the K-color toner image are superimposed in an order of Y-color, M-color, C-color, and K-color to form a full-color toner image.

Then, the perforated paper sheet P is conveyed into the image-fixing section 6, and the full-color toner image is fixed on the perforated paper sheet by the flash-fixing apparatus 60.

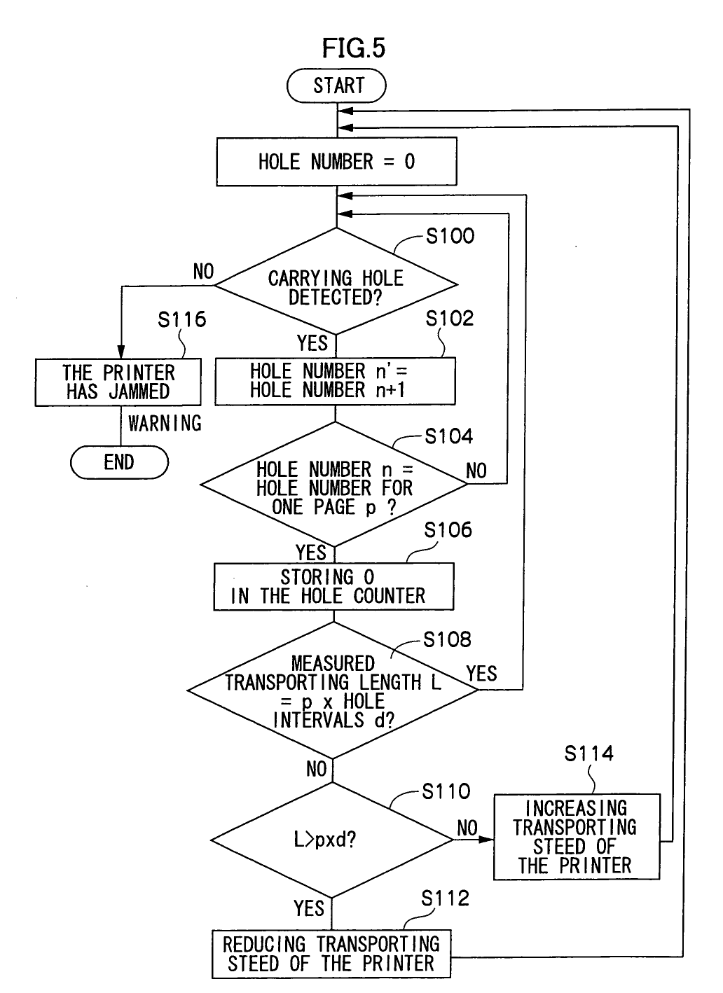

Hereinafter, the procedure by the total control computer 10 controlling the paper feeding section 2 in accordance with the data from the conveyance hole detecting apparatus 3 will be described with reference to FIG. 5.

At a step S100, the total control computer 10 judges whether the conveyance hole-detecting apparatus 3 has detected a conveyance hole h next to a definite conveyance hole h before a predetermined time has passed since the conveyance hole-detecting apparatus 3 has detected the definite conveyance hole h.

If the conveyance hole-detecting apparatus 3 has detected the next conveyance hole h, at a step S102, the total control computer 10 adds 1 to n that is a conveyance hole number stored in a conveyance hole counter thereof. Then, the total control computer 10 places a new conveyance hole number n for n+1 and stores the new conveyance hole number n in the conveyance hole.

Then, at a step S104, the total control computer 10 judges whether the conveyance hole number n has reached a conveyance hole number for one page p.

If the total control computer 10 judges that the conveyance hole number n is less than the conveyance hole number p for one page, the total control computer 10 returns to step S100 and inputs the conveyance hole detecting apparatus 3 a command of continuing counting conveyance hole number n.

On the other hand, if the total control computer 10 judges that the conveyance hole number n stored in the conveyance hole counter is equal to the conveyance hole number for one page p, the total control computer 10 goes to a step 106 and places 0 for the conveyance hole number in the conveyance hole counter. Then, at a step S108, the total control computer 10 judges whether a measured conveyance length L of the perforated paper sheet is equal to a calculated feed length given by multiplying the conveyance hole number for one page p by intervals between two adjacent conveyance holes d. The intervals between two adjacent conveyance holes d are a fixed value, e.g., 12.7 mm(½ inch). The measured conveyance length L can be calculated from a peripheral length of the main driving roller 20 and rotating velocity thereof.

If the measured conveyance length L is equal to a product of p by d, the total control computer 10 returns to step S100.

If the measured conveyance length L is not equal to the product of p by d, at step S110, it is judged whether the measured conveyance length L is larger than the product of p by d.

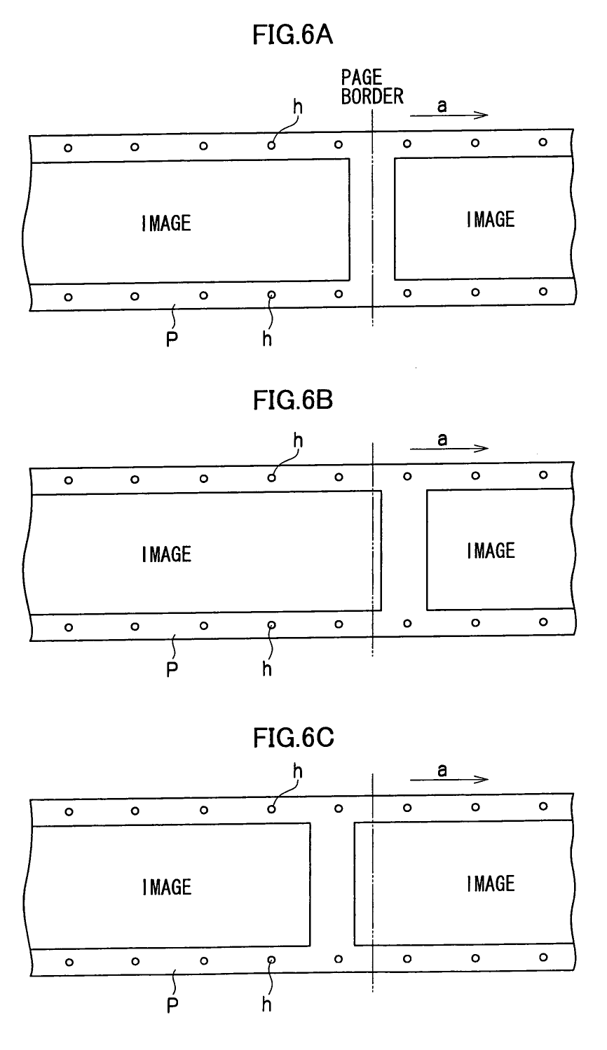

If the measured conveyance length L is larger than the product of p by d, as shown in FIG. 6B, the end of the image formed on the perforated paper sheet P is located downstream of the page border with respect to the conveyance direction ‘a’. Thus, the total computer 10 controls the paper feeding section 2 at step S112 so as to reduce the conveyance length of the perforated paper sheet P and then, returns to step S100.

On the other hand, if the measured conveyance length L is smaller than the product of p by d, as shown in FIG. 6C, the end of the image formed on the perforated paper sheet P is located upstream of the page border with respect to the conveyance direction ‘a’. Thus, the total computer 10 controls the paper feeding section 2 at step S114 so as to increase the conveyance length of the perforated paper sheet P, and returns to step S100.

The conveyance length is controlled by increasing or decreasing the rotating velocity of the main driving roller 20 so that the page border is located between two consecutive images as shown in FIG. 6A.

Further, at step S100, when the conveyance hole detecting apparatus 3 does not detect a conveyance hole next the deficient conveyance hole h in a predetermined time, e.g., a time generally required for conveying the perforated paper sheet P at a length one and a half times longer than the length d, it is judged at a step S116 that the continuous feed printer has jammed and a warning is output. At step S116, the predetermined time is more preferably a time required for feeding the perforated paper sheet at a length two times longer than the length d, since it can be prevented that the total control computer 10 detects that the continuous feed printer 100 has jammed before paper around a conveyance hole h has completely discharged.

In this embodiment, the conveyance hole number for one page p can be a whole number less than a number given by dividing the length of the perforated paper sheet P for one page by the intervals conveyance holes d. The length of the perforated paper sheet P for one page also can be a length of a page determined by perforations along which the perforated paper sheet P is folded. Moreover, the conveyance hole number for one page p can be a number having no relationship with the size of the page.

Further, the rotating velocity of the main driving roller 20 can be increased or decreased in accordance with a difference between the calculated conveyance length and the measured conveyance length. Additionally, instead of changing the rotating velocity of the driving roller 20, the timing for image writing on the photoconductor 40 can be changed to adjust the position of an image formed on the perforated paper sheet P.

In the continuous feed printer 100, since the perforated paper sheet P is conveyed frictionally, each of Y-, M-, C-, and K-color toner images can be accurately superimposed. In addition, conveyance velocity of the perforated paper sheet P is controlled so that the measured feed length L is equal to the calculated conveyance length that is the product of p by d and thus, images can be formed on the pages determined by the conveyance holes h. Therefore, the continuous feed printer 100 can be preferably employed for printing a full-color image on the perforated paper sheet P, which is automatically sealed by an automatic sealing machine.

In addition, when the conveyance hole-detecting apparatus 3 does not detect the next conveyance hole h in a specific time after a specific conveyance hole h has been detected, the total control computer 10 decides that the continuous feed printer has jammed. Therefore, any additional device for detecting jamming is not necessary for the continuous feed printer 100.

The foregoing description of the embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A continuous feed printer which prints images on a continuous paper sheet with conveyance holes perforated at regular intervals along the edges thereof and conveyed by a pinless transportation mechanism, the continuous feed printer comprising:
a conveyance hole detecting device that detects the conveyance holes;
a comparison device that compares a measured conveyance length of the perforated paper sheet, which is a length of the perforated paper sheet that is conveyed from the time when the conveyance hole detection has been started to the time when a predetermined number of conveyance holes has been detected, with a calculated conveyance length that is calculated from a number of the conveyance holes detected by the conveyance hole detecting device and the intervals between the conveyance holes; and
an adjusting device that reduces a conveyance velocity of the perforated paper sheet when the measured conveyance length is longer than the calculated conveyance length and increases the conveyance velocity of the perforated paper sheet when the measured conveyance length is shorter than the calculated conveyance length to make the measured conveyance length equal to the calculated conveyance length.

2. The continuous feed printer of claim 1, wherein the conveyance hole detecting device is a mechanical hole detector that detects the conveyance holes mechanically.

3. The continuous feed printer of claim 2, wherein the mechanical hole detector comprises a sprocket wheel having teeth engaging with the conveyance holes and detecting the conveyance holes by rotating.

4. The continuous feed printer of claim 1, wherein the conveyance hole detecting device is an optical hole detector that detects the conveyance holes optically.

5. The continuous feed printer of claim 1, wherein the conveyance hole detecting device determines that the perforated paper sheet has been jammed when the conveyance hole detecting device does not detect, after a predetermined time has passed since a conveyance hole is detected, a conveyance hole next to the conveyance hole.

6. The continuous feed printer of claim 2, wherein the conveyance hole detecting device determines that the perforated paper sheet has been jammed when the conveyance hole detecting device does not detect, after a predetermined time has passed since a conveyance hole is detected, a conveyance hole next to the conveyance hole.

7. The continuous feed printer of claim 4, wherein the conveyance hole detecting device determines that the perforated paper sheet has been jammed when the conveyance hole detecting device does not detect, after a predetermined time has passed since a conveyance hole is detected, a conveyance hole next to the conveyance hole.

8. The continuous feed printer of claim 1, further comprising an interface device that allows a user to select one of conveyance of the perforated paper sheet with reference to conveyance hole locations and conveyance of the perforated paper sheet without reference to the conveyance hole locations.

9. The continuous feed printer of claim 5, further comprising an interface device that allows a user to select one of conveyance of the perforated paper sheet with reference to conveyance hole locations and conveyance of the perforated paper sheet without reference to the conveyance hole locations.

10. The continuous feed printer of claim 6, further comprising an interface device that allows a user to select one of conveyance of the perforated paper sheet with reference to conveyance hole locations and conveyance of the perforated paper sheet without reference to the conveyance hole locations.

11. The continuous feed printer of claim 7, further comprising an interface device that allows a user to select one of conveyance of the perforated paper sheet with reference to conveyance hole locations and conveyance of the perforated paper sheet without reference to the conveyance hole locations.
